(19) United States
(12) Patent Application Publication
(10) Pub. No.: US 2012/0258692 A1
(43) Pub. Date: Oct. 11, 2012

(54) Bluetooth Display System and Method Thereof

(76) Inventor: Tai Wai LUK, Hong Kong (HK)

(21) Appl. No.: 13/083,556

(22) Filed: Apr. 9, 2011

(51) Int. Cl. H04M 1/00; H04B 5/02; H04M 3/42

(52) U.S. Cl. 455/414.1

(57) ABSTRACT

A Bluetooth display system for a cellular phone includes a user interactive unit including a display screen, and a central processing unit. The central processing unit includes a main processor, a storage device and a Bluetooth module. The storage device has a predetermined storage capacity, and is electrically connected with the main processor, wherein the storage device is pre-loaded with at least one image and the electronic phone book. The image is linked to the identification entry of the electronic phone book. The Bluetooth module is wirelessly connected to the cellular phone to selectively operate in one of an incoming call mode and an outgoing call mode.

### BACKGROUND OF THE PRESENT INVENTION

1. Field of Invention

The present invention relates to a Bluetooth display system, and more particularly to a Bluetooth display system which is capable of displaying callers' images even when conventional Bluetooth protocols are used.

2. Description of Related Arts

A conventional Bluetooth display system usually comprises an audio unit, a display, and a central processing unit electrically connected to the audio device and the display. The central processing unit comprises a processor and a Bluetooth module which is arranged to wirelessly link to a cellular phone when an incoming call is received by the cellular phone. The audio device comprises a microphone and a speaker. When a wireless connection is established between the central processing unit and the cellular phone, a user is able to have conversation with the caller through the use of the microphone and the speaker. Very often, when an incoming call is received from the cellular phone and the wireless connection between the central processing unit and the cellular phone is established, the display is arranged to illustrate the caller's number or caller's name so that the user will know who is calling to his or her cellular phone.

A major disadvantage for conventional Bluetooth hand-free system is that the display is not capable of displaying any images. When a cellular phone has a caller's image displayed on the screen, it is because the caller's image is stored in the phone book of that cellular phone. However, conventional Bluetooth protocols do not support transfer of image data from the phone book of the cellular phone to the Bluetooth hand-free system in the sense that if an image has to be transferred to a Bluetooth device from a cellular phone when there is an incoming phone call, then the transfer will take a very long period of time and becomes impractical for most situations. Thus, when the user wishes to observe the caller's image on the display, the image must be pre-loaded or transferred to the central processing unit and matched with the corresponding caller's number. The latter requirement is notoriously difficult and may need to consume a large amount of computing resources on the part of the Bluetooth hand-free system. The situation becomes worse when a particular caller has more than one phone number stored in the phone book.

On the other hand, when a user uses a Bluetooth display system to initiate dialing of a phone number, it is usually performed by voice recognition. That is, the user speaks a name of person to the Bluetooth display system. The Bluetooth display system recognizes the name and then goes on to invoke the corresponding phone number which is sent to the cellular phone for making the phone call. However, the accuracy of voice recognition is affected by environmental noises as well as the voice of the speaker. When the speaker does not speak good English but the Bluetooth display system can only recognize English, the speaker will have trouble in making phone calls.

### SUMMARY OF THE PRESENT INVENTION

An object of the present invention is to provide a Bluetooth display system and a method thereof, wherein the Bluetooth display system and the method are capable of displaying callers' images even when conventional Bluetooth protocols are used.

Another object of the present invention is to provide a Bluetooth display system and a method thereof, wherein each of the caller's images is efficiently sorted and matched with a particular caller even though that caller has more than one number stored in the phone book.

Another object of the present invention is to provide a Bluetooth display system and a method thereof, wherein the Bluetooth display system is embodied as a multi-functional watch for performing a number of functions, such as displaying time, facilitating RFID electronic transaction, or linking with a user's cellular phone to display callers' names, numbers and images.

Another object of the present invention is to provide a Bluetooth display system which is capable of facilitating dialing of a phone number through selection of images displayed by the Bluetooth display system.

In order to accomplish the above objects, the present invention provides a Bluetooth display system for a cellular phone having a built-in electronic phone book defining at least one identification entry and at least one phone number corresponding to the identification entry, wherein the Bluetooth display system comprises:

a user interactive unit comprising a display screen; and

a central processing unit which is electrically connected with the user interactive unit, and comprises:

a main processor;

a storage device, having a predetermined storage capacity, electrically connected with the main processor, wherein the storage device is pre-loaded with at least one image and the electronic phone book, wherein the images is linked to the identification entry of the electronic phone book; and

a Bluetooth module which is electrically connected to the storage device and the main processor, and is wirelessly connected to the cellular phone to selectively operate in one of an incoming call mode and an outgoing call mode, wherein in the income call mode, when an incoming call is made to the cellular phone from the phone number, data of the incoming call is wirelessly transferred to the main processor through the Bluetooth module such that the user interactive unit is arranged to provide an alert signal to the user while the contact name, the phone number and the image are displayed on the display screen, wherein in the outgoing call mode, at least one of the contact name, the phone number and the image is displayed on the display screen for user's selection, wherein when one of the contact name, the phone number and the image is selected by the user, the corresponding identification entry is invoked and a corresponding signal containing the corresponding phone number in the identification entry is wirelessly sent to the cellular phone which is arranged to dial the phone number.

The present invention also provides a method of displaying at least one caller image in a Bluetooth display system comprising a user interactive unit and a central processing unit, wherein the method comprises the steps of:

(a) pairing a cellular phone with the central processing unit of the Bluetooth display system by using predetermined Bluetooth protocols, wherein the cellular phone stores an electronic phone book containing a plurality of identification entries, wherein each of the identification entries has a contact name and a corresponding phone number;

(b) importing the electronic phone book of the cellular phone into a storage device of the central processing unit;

(c) importing a predetermined number of images into the storage device;

(d) designating each of the images to correspond with at least one contact name of at least one of the identification entries; and

(e) selectively operating in one of an incoming call mode and an outgoing call mode, wherein in the incoming call mode, when an incoming call is made to the cellular phone, displaying the identification entry and the corresponding image for alerting a user of the incoming call, wherein in an outgoing call mode, when an outgoing call is to be made, displaying at least one of a list of the contact names, the phone numbers and the images on the display screen so as to allow the user to select at least one of the contact names, the phone numbers or the images for invoking an outgoing call made from the cellular phone, wherein the outgoing call is made to a phone number corresponding with the image selected by the user on the display screen of the Bluetooth display system.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a Bluetooth display system according to a preferred embodiment of the present invention.

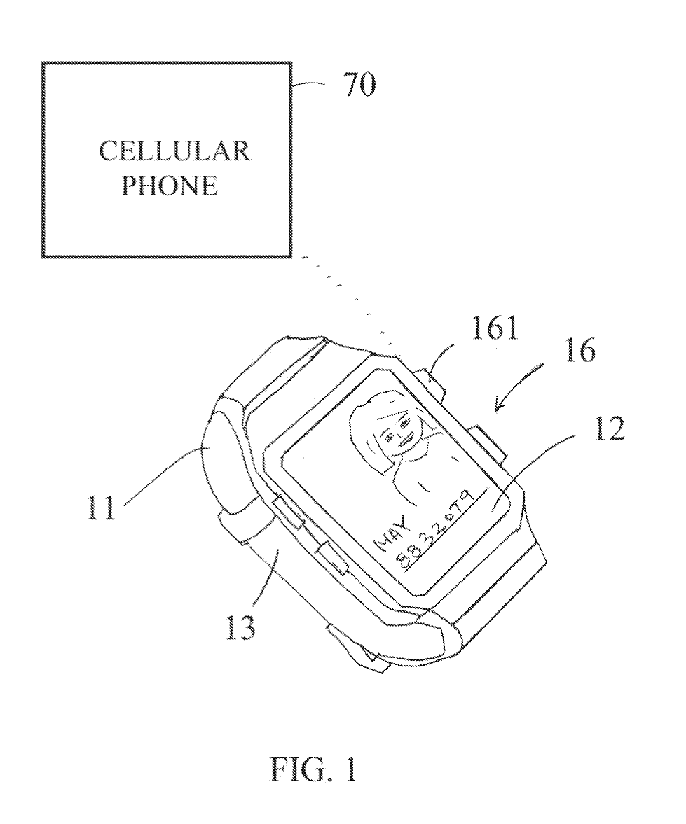

FIG. 2 is a schematic diagram of a Bluetooth display system according to the above preferred embodiment of the present invention.

FIG. 3 is a method of displaying caller's image in a Bluetooth display system according to the above preferred embodiment of the present invention.

### DETAILED DESCRIPTION OF THE PREFERRED EMBODIMENT

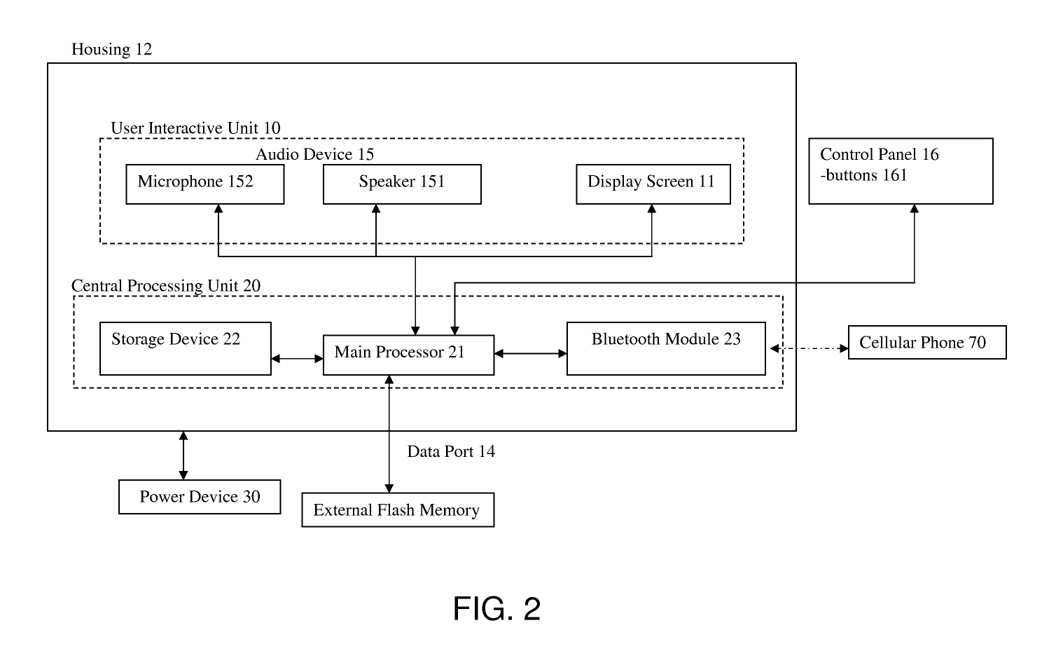

Referring to 1 to FIG. 2 of the drawings, a Bluetooth display system according to a preferred embodiment of the present invention is illustrated. The Bluetooth display system is for a cellular phone 70 having a built-in electronic phone book defining at least one (preferably a plurality of) identification entry and at least one (preferably a plurality of) phone number corresponding to the identification entry. The Bluetooth display system comprises a user interactive unit 10 comprising a display screen 11, and a central processing unit 20. On the other hand, the central processing unit 20 is electrically connected with the user interactive unit 10, and comprises a main processor 21, a storage device 22, and a Bluetooth module 23.

The storage device 22 has a predetermined storage capacity, and is electrically connected with the main processor 21, wherein the storage device 22 is pre-loaded with at least one image and the electronic phone book, wherein the images is linked to the identification entry of the electronic phone book.

The Bluetooth module 23 is electrically connected to the storage device 22 and the main processor 21, and is wirelessly connected to the cellular phone 70 to selectively operate in one of an incoming call mode and an outgoing call mode, wherein in the income call mode, when an incoming call is made to the cellular phone 70 from the phone number, data of the incoming call is wirelessly transferred to the main processor 21 through the Bluetooth module 23 such that the user interactive unit 10 is arranged to provide an alert signal to the user while the contact name, the phone number and the image are displayed on the display screen 11, wherein in the outgoing call mode, at least one of the contact name, the phone number and the image is displayed on the display screen 11 for user's selection, wherein when one of the contact name, the phone number and the image is selected by the user, the corresponding identification entry is invoked and a corresponding signal containing the corresponding phone number in the identification entry is wirelessly sent to the cellular phone 70 which is arranged to dial the phone number.

According to the preferred embodiment of the present invention, the user interactive unit 10 is preferably embodied as a watch having the display screen 11 formed thereon. The watch is arranged to perform a wide range of functions, such as displaying time and date, acting as a RFID tag for performing electronic transactions, and for displaying callers' names, numbers and images. Alternatively, the user interactive unit 10 may be equipped in a car for acting as a hand-free dialing system.

As a result, the user interactive unit 10 further comprises a housing 12, a plurality of fasteners 13 extended from the housing 12 to fasten on a user's hand. Each of the fasteners 13 is preferably embodied as a watch band extended from the housing 12 and is adapted for being fastened onto a user's hand. The central processing unit 20 is received in the housing 12 for carrying out the function described above.

The user interactive unit 10 further comprises at least one data port 14 provided on the housing 12 and is electrically connected to the central processing unit 20 for allowing data, such as image files or the electronic phone book of the cellular phone 70 to be imported and stored into the central processing unit 20. Thus, the data port 14 may be connected to a computer or an external flash memory for allowing import of the image files.

Each of the identification entries contained in the phone book of the cellular phone 70 and is imported into the central processing unit 20 contains a contact name and at least one corresponding phone number. On the other hand, the central processing unit 20 is arranged to be imported with the electronic phone book of the cellular phone 70 and the images of the caller's, wherein each of the identification entries is matched with a predetermined caller's image so that when an incoming call is made to the cellular phone 70, the identification entry and the corresponding phone number is shown on the display screen 11, along with the predetermined image which corresponds to the caller. Thus, when the user interactive unit 10 is embodied as a watch, the caller's name, phone number and a pre-loaded image of the caller will be shown on the display screen 11 by using traditional Bluetooth protocols.

The user interactive unit 10 further comprises an audio device 15 which is provided on the housing 12, and comprises a speaker 151 and a microphone 152 electrically connected to the central processing unit 20, wherein the Bluetooth display system is paired with the cellular phone 70, and a user may be able to make conversation with the caller through the audio device 15. In other words, the user may rely on the user interactive unit 10 for being alerted to and for answering an incoming call made to the cellular phone 70.

It is worth mentioning that the images can be imported into the central processing unit 20 through a number of methods. First, the images can be loaded to the central processing unit 20 through the data port 14. Alternatively, the images can be wirelessly transmitted to the central processing unit 20 from the cellular phone or other devices, such as from a computer. The most important point is that the present invention facilitates image display on the user interactive unit 10 when only the traditional Bluetooth protocols are used for transferring the electronic phone book into the central processing unit 20. Thus, traditional Bluetooth protocols are not being used to transmit callers' images, yet pre-loaded callers' images are accurately matched to the corresponding identification entry of the electronic phone book.

In order to control the operation of the Bluetooth display system, the user interactive unit 10 further comprises a control panel 16 provided thereon for allowing the user to input commands to the user interactive unit 10 and the central processing unit 20. Since the user interactive unit 10 is preferably embodied as a watch, the control panel 16 comprises a plurality of buttons 161 provided on the housing 12 for allowing the user to actuate thereon. Note that the buttons 161 can be embodied as mechanical buttons or capacitive touch buttons formed on a touch screen.

It is worth mentioning that since the user interactive unit 10 is embodied as a watch, the Bluetooth display system further comprises a power device 30 provided in the user interactive unit 10 for providing power thereto and to the central processing unit 20. The power device 30 is preferably embodied as a replaceable or rechargeable battery for providing a predetermined amount of power to the user interactive unit 10 and the central processing unit 20. When the user interactive unit 10 is equipped in a car, the power device 30 is connected to the car's power source.

Furthermore, the electronic phone book of the cellular phone 70 and the images may be transferred to a computer, wherein each of the images may be matched with at least one contact name of an identification entry by a predetermined program installed in the computer. After all of the images are matched with a corresponding contact name, the entire phone book and along with the images are imported into the user interactive unit 10 and stored in the storage device 22 in such a manner that when an incoming call is made to the cellular phone 70, the contact name, the phone number and the corresponding image are displayed on the display screen 11. In other words, the matching of the image and each of the identification entries is performed by a computer.

Apart from displaying the caller's image when an incoming call is made to the cellar phone 70 (i.e. the incoming call mode), the images stored in the storage device 22 may also be selected by the user for calling a phone number associated with that image (i.e. the outgoing call mode). Thus, when a user wishes to dial a phone number through the cellular phone 70, he or she may activate a calling function of the Bluetooth display system such that a list of the identification entries (i.e. the contact name or the phone number) or the images is shown on the display screen. After that, a user may select one image from the list of images. Once the image is selected, the corresponding identification entry is invoked and the central processing unit 20 is arranged to send a corresponding signal (i.e. the information regarding the phone number) to the cellular phone 70 via predetermined Bluetooth protocols. Once the cellular phone 70 receives the signals, the cellular phone 70 is activated to perform the dialing process. The user is then able to use the Bluetooth display system or the cellular phone 70 for making the phone conversation.

In this preferred embodiment, there are two mechanisms in making a phone call by selecting an image. In the first mechanism, the central processing unit 20 may generate a favorite section on the display screen 11. Dialing a phone from a favorite section allows the user to select a target image and actuate a predetermined control button 161 to confirm calling. When the user confirms the image by actuating the control button 161, the central process unit 20 is arranged to send out the corresponding phone number to the cellular phone 70. Upon receipt of the phone number, the cellular phone is activated to make the phone call.

In the second mechanism, it is for general image dialing. For example, when there are ten identification entries stored in the storage device 22, each of the identification entries is linked with an image. When a contact has been invoked, each of corresponding phone numbers is shown on the display screen 11. The user is then able to utilize the control panel 16 to select which number associated with the contact name is to be dialed. The phone number is then transferred to the cellular phone 70 which performs the corresponding dialing. Thus, there is no favorite section in this second mechanism.

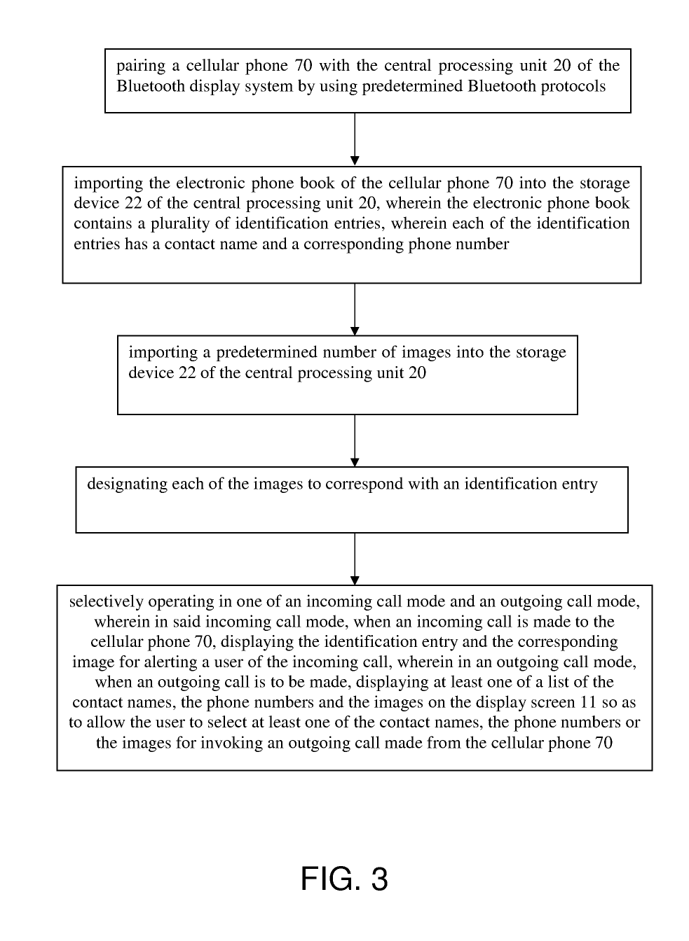

As shown in FIG. 3 of the drawings, a method of displaying at least one caller image in a Bluetooth display system according to a preferred embodiment of the present invention is illustrated, in which the method comprises the steps of:

(a) pairing a cellular phone 70 with the central processing unit 20 of the Bluetooth display system by using predetermined Bluetooth protocols;

(b) importing the electronic phone book of the cellular phone 70 into the storage device 22 of the central processing unit 20, wherein the electronic phone book contains a plurality of identification entries, wherein each of the identification entries has a contact name and a corresponding phone number;

(c) importing a predetermined number of images into the storage device 22 of the central processing unit 20;

(d) designating each of the images to correspond with an identification entry; and

(e) selectively operating in one of an incoming call mode and an outgoing call mode, wherein in said incoming call mode, when an incoming call is made to the cellular phone 70, displaying the identification entry and the corresponding image for alerting a user of the incoming call, wherein in an outgoing call mode, when an outgoing call is to be made, displaying at least one of a list of the contact names, the phone numbers and the images on the display screen 11 so as to allow the user to select at least one of the contact names, the phone numbers or the images for invoking an outgoing call made from the cellular phone 70, wherein the outgoing call is made to a phone number corresponding with the image selected by the user on the display screen of the Bluetooth display system.

According to the preferred embodiment of the present invention, the importing step as mentioned in step (b) is through predetermined Bluetooth protocols which facilitate wireless transfer of the electronic phone book stored in the cellular phone 70.

In step (c), the importing of the images into the central processing unit 20 can be accomplished through various methods and techniques. For example, the image data can be transferred to the central processing unit 20 through the data port 14 and a cable. For example, the user interactive unit 10 can be electrically connected to a computer for acquiring the image files. Alternatively, the image files can be wirelessly transferred to the user interactive unit 10 by using Bluetooth technology. This is different from transferring the whole electronic phone book from the cellular phone 70 because the image files transferred using Bluetooth technology are not sorted and designated to match with the corresponding identification entries contained in the electronic phone book.

Step (d) comprises a step of matching each of the images to at least a contact name of a particular identification entry. For example, when a particular identification entry has a contact name “David” and three different phone numbers (e.g. a home phone number, an office phone number and a cellular phone number), the image is linked to the name “David” of that particular identification entry irrespective of how many phone number is saved for that identification entry. In other words, when in incoming call is made to the cellular phone in which the incoming number is one of the three phone numbers contained in the identification entry having the contact name “David”, the image linked with “David” is displayed on the display screen 11.

Alternatively, the relevant images may be linked to all of the contact names contained in that identification entry so that each of the contact name and the phone number has an image linked to it. In this regard, the three contact names may be linked to three different images respectively so that there are three different images displayed on the display screen 11 even when the calls are from the same caller.

The matching step described in step (d) can be accomplished manually. This means each of the image files is manually matched or linked to at least one contact name of an identification entry. As mentioned above, for each identification entry, each of the contact names may be manually linked to an image.

The method further comprises a step, in between step (c) and step (d), of sorting each of the identification entries in a predetermined order so as to facilitate easy linking of the images to each of the identification entries. For example, the identification entries imported into the user interactive unit 10 may be sorted according to alphabetical order of the contact name. Thus, for an electronic phone book having three identification entries having contact names “Andy”, “Bernard” and “Cathy” respectively, the identification entries will be sorted to begin with “Andy”, followed by “Bernard”, and followed by “Cathy”. Then, the user is able to link each of the images to the identification entries.

From the above descriptions, it can be appreciated that the main advantage of the present invention is that the user interactive unit 10 can utilize traditional Bluetooth communication protocols to obtain the electronic phone book form the cellular phone 70. At the same time however, the images can be loaded to the user interactive unit 10 and matched with each of the identification entries stored in the electronic phone book (and which is transferred to the user interactive unit 10). When an incoming call is received from the cellular phone 70, the cellular phone 70 is arranged to wirelessly transmit the incoming number to the Bluetooth module 23 of the central processing unit 20. The main processor 21 is arranged to process the signal and the incoming number is matched with the number of the electronic phone book stored in the storage device 23. When one of the phone numbers is matched, the corresponding identification entries will be invoked. After that, the contact name, the phone number, and the pre-matched image corresponding to that identification entry or the contact name will be displayed on the display screen 11 of the user interactive unit 20.

Thus, step (e) comprises the steps of:

(e.1) wirelessly transmitting the incoming phone number to the Bluetooth module 23 by using a predetermined Bluetooth protocol;

(e.2) matching the incoming phone number to one of the phone number stored in the storage device;

(e.3) when the incoming phone number matches with the any phone number stored in the storage device, invoking the corresponding identification entry; and

(e.4) displaying the contact name, the phone number and the corresponding image on the display screen 11 of the user interactive unit 10 for alerting the user of the incoming call.

As mentioned above, the method of displaying the caller's image may also be made in the context of making a phone call through the cellular phone 70. Thus, step (e) further comprises the steps of:

(e.5) displaying a plurality of images on the display screen 11 for user's selection;

(e.6) when an image is selected, invoking the identification entry corresponding to the selected image;

(e.7) wirelessly transmitting at least one of the phone number and the corresponding contact name to the cellular phone 70 via the Bluetooth module 23 of the central processing unit 20 by using a predetermined Bluetooth protocol; and

(e.8) invoking the cellular phone 70 to dial the corresponding phone number.

As one may appreciate, steps (e.1) to (e.4) involves the incoming call mode for displaying the caller's image when an incoming call is made, while steps (e.5) to (e.8) involves the outgoing call mode which allows the user to select one identification entry when an outgoing call is to be made.

One skilled in the art will understand that the embodiment of the present invention as shown in the drawings and described above is exemplary only and not intended to be limiting. It can be appreciated that the objects of the present invention have been fully and effectively accomplished. The above-described embodiments have been shown and described for the purposes of illustrating the functional and structural principles of the present invention and is subject to change without departure from the spirit and the main patentable subject matter of the present invention. Therefore, this invention includes all modifications encompassed within the spirit and scope of the following claims.

What is claimed is:

1. A Bluetooth display system for a cellular phone having a built-in electronic phone book defining at least one identification entry having at least one contact name and at least one corresponding phone number, wherein said Bluetooth display system comprises:
a user interactive unit comprising a display screen; and
a central processing unit which is electrically connected with said user interactive unit, and comprises:
a main processor;
a storage device, having a predetermined storage capacity, electrically connected with said main processor, wherein said storage device is pre-loaded with at least one image and said electronic phone book, wherein said images is linked to said contact name of said identification entry of said electronic phone book; and
a Bluetooth module which is electrically connected to said storage device and said main processor, and is wirelessly connected to said cellular phone to selectively operate in one of an incoming call mode and an outgoing call mode, wherein in said income call mode, when an incoming call is made to said cellular phone from said phone number, data of said incoming call is wirelessly transferred to said main processor through said Bluetooth module such that said user interactive unit is arranged to provide an alert signal to said user while said contact name, said phone number and said image are displayed on said display screen, wherein in said outgoing call mode, at least one of said contact name, said phone number and said image is displayed on said display screen for user's selection, wherein when one of said contact name, said phone number and said image is selected by said user, said corresponding identification entry is invoked and a corresponding signal containing said corresponding phone number in said identification entry is wirelessly sent to said cellular phone which is arranged to dial said phone number.

2. The Bluetooth display system, as recited in claim 1, wherein said user interactive unit further comprises at least one data port provided thereon to electrically connect to said central processing unit for allowing data to be imported and stored into said central processing unit through said data port.

3. The Bluetooth display system, as recited in claim 2, wherein said central processing unit is arranged to be imported with said electronic phone book of said cellular phone and said corresponding image, wherein said identification entry is matched with said image so that when an incoming call is made to said cellular phone, said identification entry and said corresponding phone number is shown on said display screen, along with said predetermined image.

4. The Bluetooth display system, as recited in claim 3, wherein said user interactive unit is embodied as a watch and comprises a watch housing, and a plurality of fasteners extended from said housing to fasten on an external object.

5. The Bluetooth display system, as recited in claim 4, wherein said user interactive unit further comprises an audio device provided thereon, wherein when said central processing unit is paired with said cellular phone, a user is able to make conversation to a caller through said audio device.

6. The Bluetooth display system, as recited in claim 4, wherein said user interactive unit further comprises a control panel provided thereon for allowing said user to input commands to said user interactive unit and said central processing unit.

7. The Bluetooth display system, as recited in claim 5, wherein said user interactive unit further comprises a control panel provided thereon for allowing said user to input commands to said user interactive unit and said central processing unit.

8. A method of displaying at least one caller image in a Bluetooth display system comprising a user interactive unit and a central processing unit, wherein said method comprises the steps of:
(a) pairing a cellular phone with said central processing unit of said Bluetooth display system by using predetermined Bluetooth protocols, wherein said cellular phone stores an electronic phone book containing a plurality of identification entries, wherein each of said identification entries has a contact name and a corresponding phone number;
(b) importing said electronic phone book of said cellular phone into a storage device of said central processing unit;
(c) importing a predetermined number of images into said storage device;
(d) designating each of said images to correspond with at least one contact name of at least one of said identification entries; and
(e) selectively operating in one of an incoming call mode and an outgoing call mode, wherein in said incoming call mode, when an incoming call is made to said cellular phone, displaying said identification entry and said corresponding image for alerting a user of said incoming call, wherein in an outgoing call mode, when an outgoing call is to be made, displaying at least one of a list of said contact names, said phone numbers and said images on said display screen so as to allow said user to select at least one of said contact names, said phone numbers and said images for invoking an outgoing call made from said cellular phone, wherein said outgoing call is made to a phone number corresponding with said image selected by said user on said display screen of said Bluetooth display system.

9. The method, as recited in claim 8, wherein said step (e) comprises the steps of:
wirelessly transmitting said incoming phone number to a Bluetooth module of said central processing unit by using a predetermined Bluetooth protocol;
matching said incoming phone number to one of said phone numbers stored in said storage device of said central processing unit;
when said incoming phone number matches with said any phone number stored in said storage device, invoking said corresponding identification entry; and
displaying said contact name, said phone number and said corresponding image on a display screen of said user interactive unit for alerting said user of said incoming call.

10. The method, as recited in claim 8, wherein said step (e) comprises the steps of:
displaying at least a list of said contact names, said phone numbers and said images on said display screen for user's selection;
when one of said contact names, said phone numbers and said images is selected, invoking identification entry corresponding to said user's selection;
wirelessly transmitting at least one of said phone number, said corresponding contact name to said cellular phone via said Bluetooth module of said central processing unit by using a predetermined Bluetooth protocol; and
invoking said cellular phone to dial said corresponding phone number.

11. The method, as recited in claim 9, wherein step (e) further comprises the steps of:
displaying at least a list of said contact names, said phone numbers and said images on said display screen for user's selection;
when one of said contact names, said phone numbers and said images is selected, invoking identification entry corresponding to said user's selection;
wirelessly transmitting at least one of said phone number, said corresponding contact name to said cellular phone via said Bluetooth module of said central processing unit by using a predetermined Bluetooth protocol; and
invoking said cellular phone to dial said corresponding phone number

12. The method, as recited in claim 10, wherein said step (d) comprises a step of manually matching each of said images to at least one of said contact names of said corresponding identification entry in said user interactive unit.

13. The method, as recited in claim 11, wherein said step (d) comprises a step of manually matching each of said images to at least one of said contact names of said corresponding identification entry in said user interactive unit.

14. The method, as recited in claim 12, further comprising, in between said step (c) and said step (d), a step of sorting each of said identification entries in a predetermined order so as to facilitate easy linking of said images to each of said identification entries.

15. The method, as recited in claim 13, further comprising, in between said step (c) and said step (d), a step of sorting each of said identification entries in a predetermined order so as to facilitate easy linking of said images to each of said identification entries.

16. The method, as recited in claim 14, wherein in said sorting step, said contact names of said identification entries are imported into said user interactive unit and are sorted according to alphabetical order of said contact names.

17. The method, as recited in claim 15, wherein in said sorting step, said contact names of said identification entries are imported into said user interactive unit and are sorted according to alphabetical order of said contact names.

18. The method, as recited in claim 17, wherein said importation of said electronic phone book in said step (b) is accomplished through predetermined Bluetooth protocols which facilitate wireless transfer of said electronic phone book stored in said cellular phone.

19. The method, as recited in claim 18, wherein said corresponding images are linked to all of said contact names contained in said corresponding identification entry respectively so that each of said contact names and said phone numbers is linked to said corresponding image.

20. The method, as recited in claim 18, wherein at least one of said corresponding images is linked to all of said contact names contained in one of said corresponding identification entry so that each of said contact names in said corresponding identification entry shares said corresponding image.
